(19) United States
(12) Patent Application Publication
(10) Pub. No.: US 2026/0077478 A1
(43) Pub. Date: Mar. 19, 2026

(54) ROBOTIC ARM

(71) Applicant: ABB SCHWEIZ AG, BADEN (CH)

(72) Inventors: Kaiyuan Cao, Shanghai (CN); Jiafan Zhang, Shanghai (CN)

(21) Appl. No.: 19/398,736

(22) Filed: Nov. 24, 2025

Related U.S. Application Data
(63) Continuation of application No. PCT/CN2023/096288, filed on May 25, 2023.

(51) Int. Cl. B25J 9/00; B25J 18/00

(52) U.S. Cl. CPC B25J 9/0012; B25J 18/00

(57) ABSTRACT

An arm body for a robotic arm includes a first tubular body made of plastic material, including a first tubular portion including a first axial opening and a second tubular portion the first tubular body being substantially closed except the first axial opening and the second axial opening. A first connecting portion is provided at the first tubular portion and includes a first mounting surface configured to be connected to a first component constituting a robot; and a second connecting portion provided at the second tubular portion and including a second mounting surface configured to be connected a second component constituting the robot.

### FIELD

Embodiments of the present disclosure generally relate to an industrial robot, and more specifically, to a robotic arm made of plastic material.

### BACKGROUND

Industrial robots are widely used in various industry fields. An industrial robot typically comprises a robotic arm formed by a plurality of axial joints, each joint including a casing and an actuator arranged therein, and a plurality of structural arms connecting the adjacent joints. An end effector may be fixed to an end flange of the robotic arm and are designed to perform various tasks. The casing of the joint and the structural arms are load bearing members and are designed with sufficient strength to withstand loads. Typically, these structural members are made of lightweight metals, such as aluminum alloys, to ensure sufficient structural strength.

There is an increasing trend of using plastic material to replace the metal to construct these structural members. This may bring about a number of advantages. Since load bearing structural members of the robotic arm are made of plastic material, they can be manufactured, for example, via injection molding, which significantly reduces the manufacturing costs of the industrial robot, obviates need to painting their outer surfaces while it can ensure its lightweight.

### SUMMARY

Example embodiments of the present disclosure provide an arm body mainly made of plastic material, a robotic arm and an industrial robot with improved structural strength.

In a first aspect of the present disclosure, there is provided an arm body for a robotic arm. The arm body comprises a first tubular body made of plastic material, comprising a first tubular portion comprising a first axial opening communicating with an inner chamber of the tubular body and a second tubular portion comprising a second axial opening communicating with the inner chamber, the first tubular body being substantially closed except the first axial opening and the second axial opening; a first connecting portion provided at the first tubular portion and comprising a first mounting surface configured to be connected to a first component constituting a robot; and a second connecting portion provided at the second tubular portion and comprising a second mounting surface configured to be connected a second component constituting the robot. With this arrangement, as for a plastic arm body, since there is no work opening provided in the arm body, the structural strength of the arm body is greatly improved and sealing performances of the arm body is improved.

In some embodiments, at least one connecting portion of the first connecting portion and the second connecting portion may be made of metal; and the respective mounting surface of the at least one connecting portion extends in a lengthwise direction in which the respective axial opening extends. With this arrangement, the arm body can be connected to other components constituting the robot at a radial outer side of the tubular body.

In some embodiments, the at least one connecting portion may be a ring-shaped member; and the at least one connecting portion may comprise a plurality of first mounting holes circumferentially distributed along the respective mounting surface, the first mounting hole extending in a thickness direction of the at least one connecting portion perpendicular to the lengthwise direction and configured to receive a screw fastener. With this arrangement, the arm body can be connected to other components constituting the robot via the mounting holes.

In some embodiments, the at least one connecting portion may be integrally formed with the first tubular body by insert molding or adhesive.

In some embodiments, at least one of the first connecting portion and the second connecting portion may comprise an annular flange portion protruding from an inner surface of the respective tubular portion to partially block the respective axial opening, or a plurality of connecting posts arranged around the respective axial opening and extending in an axial direction in which the respective axial opening extends, an axial end surface of the annular flange portion or an axial plane defined by axial end surfaces of the plurality of connecting posts forming the respective mounting surface, and the annular flange portion or the plurality of connecting posts is integrally formed with the first tubular body by injection molding. With this arrangement, the arm body can be connected to other components constituting the robot via the annular flange portion.

In some embodiments, the annular flange portion or the plurality of connecting posts may be made of metal and may comprise a second mounting hole for screw connection; and the second mounting hole is configured to receive screw fasteners from a side of the axial opening opposite to the inner chamber. With this arrangement, the arm body can be connected to other components constituting the robot at the annular flange portion via the mounting holes.

In some embodiments, the annular flange portion or the plurality of connecting posts may be made of the plastic material; a second mounting holes may be provided in the annular flange portion or the connecting post, the second mounting holes is provided with a metal insert therein; and the metal insert may be configured to receive a screw fastener from a side of the axial opening opposite to the inner chamber.

In some embodiments, the annular flange portion or the plurality of connecting posts may be made of the plastic material; a metal plate may be arranged within the annular flange portion or the plurality of connecting posts; and the metal plate may comprise a second mounting hole for screw connection and configured to receive a screw fastener from a side of the axial opening opposite to the inner chamber.

In some embodiments, the annular flange portion or the plurality of connecting posts may be provided within the inner chamber at a distance from a terminal end of the respective tubular portion.

In some embodiments, the annular flange portion or the plurality of connecting posts may be provided at a terminal end of the respective tubular portion.

In a second aspect of the present disclosure, there is provided a robotic arm. The robotic arm comprises an arm body according to according to a first aspect of the present disclosure; and a first actuator comprising a fixed part and a movable part, the fixed part being received within an inner chamber of a first tubular body of the arm body and being fixed to the arm body via one of a first connecting portion and a second connecting portion of the arm body.

In some embodiments, the robotic arm may further comprise a second arm body comprising a second tubular body made of plastic material and a third axial opening and a fourth axial opening at opposite ends of the second tubular body, the second tubular body being substantially closed except the third axial opening and the fourth axial opening; a third connecting portion provided at the third axial opening and comprising a third mounting surface; and a fourth connecting portion provided at the fourth axial opening and comprising a fourth mounting surface; and wherein the second tubular body is fixed to the first tubular body via engagement of one of the third mounting surface and the fourth mounting surface with one of the first mounting surface and the second mounting surface.

In some embodiments, the first tubular body may be curved in an L-shape, and/or the second tubular body may be in a straight arm shape.

In some embodiments, the robotic arm may further comprise a third arm body comprising a third tubular body made of plastic material and a fifth axial opening and a sixth axial opening at opposite ends of the third tubular body; a fifth connecting portion provided at the fifth axial opening and comprising a fifth mounting surface; and a sixth connecting portion provided at the sixth axial opening and comprising a sixth mounting surface; and wherein at least part of the movable part of the first actuator comprises a plurality of third mounting holes and extends beyond a terminal end of the first tubular body, and the third arm body is fixed to the first arm body via engagement of the at least part of the movable part and one of the fifth mounting surface and the sixth mounting surface.

In some embodiments, the robotic arm may further comprise a second actuator comprising a fixed part and a movable part, wherein the fixed part of the second actuator is received within an inner chamber of the third tubular body and comprise a plurality of fourth mounting holes, and the second actuator is fixed to the third arm body via engagement of the fixed part and the other mounting surface of the fifth mounting surface and the sixth mounting surface.

In a third aspect of the present disclosure, there is provided an industrial robot. The industrial robot comprises a base, and a robotic arm comprising an arm body according to a first aspect of the present disclosure.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is an overall view of an industrial robot according to one example embodiment of the present disclosure;

FIG. 2 is a perspective view of a robotic arm including one arm body according to a first example embodiment of the present disclosure;

FIG. 3 is a sectional view of FIG. 2, showing structural details of a mounting interface;

FIG. 4 is a sectional view of FIG. 2, with an actuator being provided within the arm body of the robotic arm;

FIG. 5 is a sectional view of a robotic arm analogous to FIG. 4 including one arm body according to a second example embodiment of the present disclosure, with an actuator being provided within the casing of the robotic arm;

FIG. 6 is a perspective view of a robotic arm including one arm body according to a third example embodiment of the present disclosure;

FIG. 7 is a sectional view of FIG. 6;

FIG. 8 is a perspective view of a robotic arm including two arm bodies according to one example embodiment of the present disclosure;

FIG. 9 is a sectional view of FIG. 8;

FIG. 10 is a perspective view of a robotic arm including one arm body according to a fourth example embodiment of the present disclosure;

FIG. 11 is a sectional view of FIG. 10;

FIG. 12 is a plane view of a robotic arm including three arm bodies according to one example embodiment of the present disclosure;

FIG. 13 is a sectional view of FIG. 12, with the first and second connection portions of the arm body being of different forms; and

FIG. 14 is a sectional view of FIG. 12, the first and second connection portions of the arm body being of the same forms.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

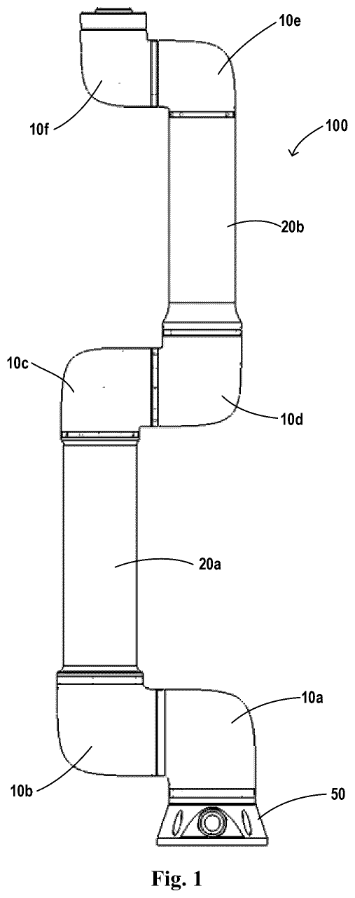

FIG. 1 is an overall view of an industrial robot 100 according to one example embodiment of the present disclosure. As shown in FIG. 1, the industrial robot 100 comprises a base 50, a plurality of joints (in the show example, its outer casing is shown and is labeled as 10a, 10b, 10c, 10d, 103e, 10f), and a plurality of connecting arms 20 (labeled as 20a, 20b in the showing example) connecting two adjacent joints. Each joint may include a casing or an arm body and an actuator may be provided therein. The actuator, for example, may include a motor, a reduction gear, sensors, and the like, as well known in the art. A controller may be provided in the base 50. The actuators within the casing can be controlled based on instructions from the controller so as to control a posture of the robotic arm and/or a movement path of an end effector provided at the distal end of the robotic arm.

The casing of the joint and the connecting arms 20 are load bearing members and are designed with sufficient strength. As mentioned above, due to the fact that the plastic member can be manufactured by injection molding, which means lower manufacturing costs and many complex steps that are needed in processing conventional metal members can be omitted, there thus is technical trend that using plastic material to manufacture the casing and the connecting arms. However, a number of challenges exist when the plastic material is used to manufacture the casing and the connecting arms.

One challenge is that conventional casing of the joint is provided with one or more work opening at its outer surface. Through the work openings, inner chamber of the casing can be accessed by an engineer so as to assemble the actuator within a hollow chamber of the casing and also makes it possible, for the engineer, to perform maintenance work when the components within the casing fail. However, existence of these working openings is not desired. These working openings decrease the structural strength of the plastic robotic arm which is crucial for operation of the robotic arm. Moreover, in many critical applications, for example, food industries, pharmaceutical industries, and the like, the existence of working openings poses high requirements of sealing performances at the working openings so as meet hygienic requirements. Also, these working openings are generally be closed by covers, and provision of covers also increases manufacturing costs of the robotic arm. According to the present disclosure, a novel robotic arm is provided which makes it possible to assembly the components of an actuator and the connecting arm without the working openings.

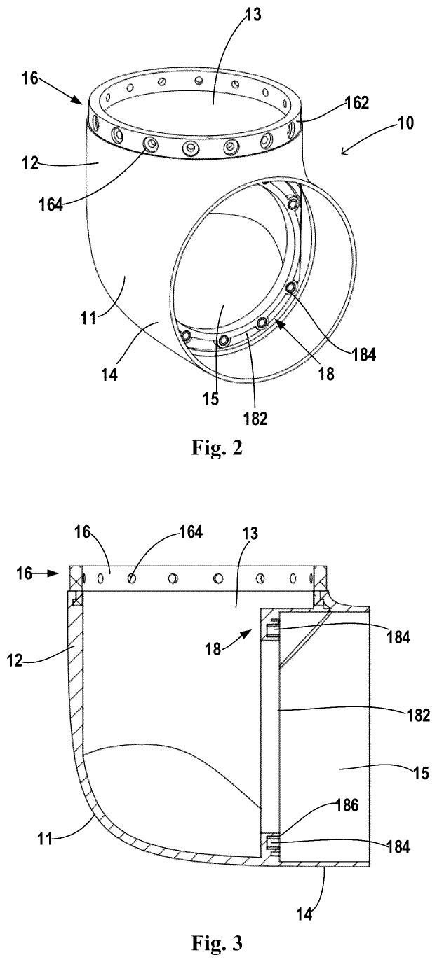

FIGS. 2-4 show a robotic arm including one arm body according to a first example embodiment of the present disclosure. As shown in FIGS. 2-4, the robotic arm body 10 includes a tubular body 11 made of plastic material. The arm body 10 is of a tubular shape defining an inner chamber. Components of an actuator 30 can be arranged within the inner chamber. The actuator 30, among the others, may include a movable part 34 and a fixed part 32. The fixed part 32 may include a stator of a motor. The movable part, among the others, may include a rotor of the motor. The rotor is configured to rotate around an axial direction. A reduction gear may be connected to the rotor. Components to be driven, for example, an adjacent connecting arm, may be further connected to the reduction gear. Thus, the adjacent connecting arm may be driven to rotate around the axial direction.

The tubular body 11 may include a first tubular portion 12 and a second tubular portion 14 at its opposite ends. In the shown example, the first tubular portion 12 and the second tubular portion 14 may be curved in an L-shape. An end wall of the first tubular portion 12 defines a first axial opening 13 communicating with the inner chamber of the tubular body. The axial direction is corresponding to a direction that the axial opening opens and is also corresponding to an axial direction around which the adjacent connecting arm rotates.

A first connecting portion 16 is provided at the first tubular portion 12. The first connecting portion 16 includes a first mounting surface 162. The term “mounting surface” herein means a surface of a first member that is configured to engage a corresponding surface of a second member via a surface contact, and the first member and the second member thus can be fixed to each other in a manner of surface contact. Via the surface contact, sufficient connection strength can be realized. Likewise, an end wall of the second tubular portion 14 defines a second axial opening 15 communicating with the inner chamber of the tubular body. The second connecting portion 18 is provided at the second tubular portion 14. The second connecting portion 18 includes a second mounting surface 182. In the shown example, a cross section of the tubular body is a circular shape. It is to be understood that this is merely illustrate the tubular body may be of any other closed shapes, for example, a rectangle shape.

As shown in FIGS. 2-4, the tubular body 11 of the arm body 10 is substantially closed except the first axial opening 13 and the second axial opening 15. There is no provision of a work opening in the casing of the arm body. With this arrangement, a structural strength is increased compared to a conventional casing provided with a work opening. Also, the hygienic requirements for some specific applications can be meet.

In some embodiments, the first connecting portion 16 may be made of metal. This is advantageous for ensuring connection strength of the plastic arm body 10 with another plastic arm body. When the two arm bodies for forming the robotic arm are made of plastic material, the plastic material is subject to a creep risk if operates under stress over a long term. When the robotic arm works over time, there is a high risk that connection between the two plastic components (for example, screw connection) becomes loose. When metal is used at the connecting position of two plastic components, the above mentioned creep risk can be avoided and connection strength of the two plastic components constituting the robot can be ensured.

The first connecting portion 16 may be a metal ring which extends in a lengthwise direction in which the axial opening opens. The lengthwise direction is corresponding to the axial direction that the opening extends. The outer or inner surface of the metal ring may be used as the mounting surface. When the tubular body is of a cylindrical shape, the radial outer or inner circumferential surface of the metal ring is used as the mounting surface 162. There are various means for forming the first connecting portion 16. In some embodiments, the first connecting portion 16 may be integrally formed with the tubular body via insert molding. In some embodiments, the first connecting portion 16 may be mechanically fixed to the tubular body, for example, via adhesion and the like.

The first connecting portion 16 may include a plurality of first mounting holes 164 for screw connection. The first mounting holes 164 are circumferentially distributed along the mounting surface 162. The first mounting hole 164 extends in a thickness direction of the first connecting portion 16. The thickness direction of the first connecting portion 16 is perpendicular to the lengthwise direction. Since the first mounting holes 164 are radially arranged, an engineer can easily access the first mounting holes from a radial outside of the arm body without need to access an inner side of the arm body. The mounting hole 164 may be through holes or thread holes in accordance with the position of the first connecting portion 16 when two plastic components are connected.

In some embodiments, the first connecting portion 16 may be integrally formed with the first tubular body 11 by insert molding. In some embodiments, the first connecting portion 16 may be fixed to the first tubular body 11 via adhesive.

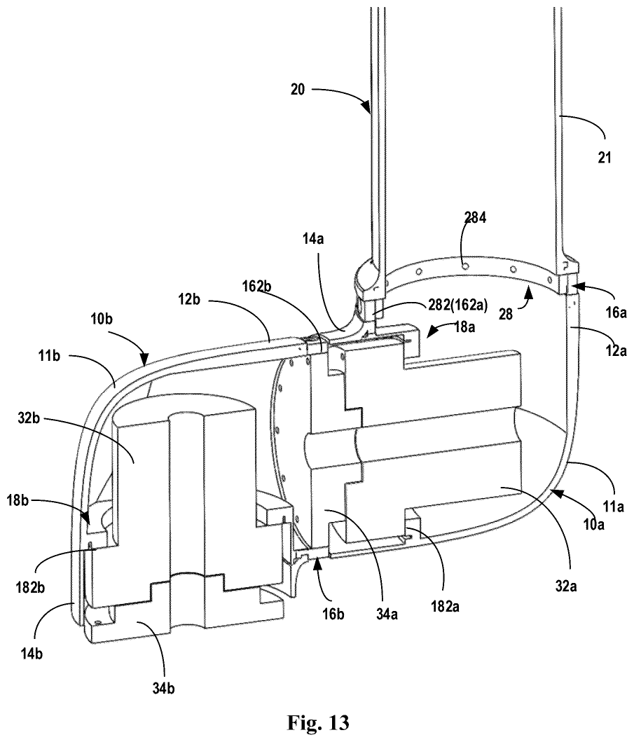

An operating manner of the first connecting portion 16 (labeled as 16a in FIG. 13) is best shown in FIG. 13. As shown in FIG. 13, a first connecting portion 16a is located at one axial end of a first arm body 10a. Another arm body 20 includes a connecting portion 28. The connecting portion 28 includes a mounting surface 282. The connecting portion 28 of the arm body 20 may be in a form of metal ring and takes the substantially same configuration as the first connecting portion 16a. Both the mounting surface 162 of the first connecting portion 16a and the mounting surface 282 of the connecting portion 28 extend lengthwise along the axial direction. The connecting portion 28 may include a plurality of mounting holes 284 in a thickness direction. Likewise, the mounting surface 162 of the first connecting portion 16a includes a plurality of mounting holes 162. When the first arm body 10a and the arm body 20 are placed in position and are to be assembled, the mounting surface 162 of the first connecting portion 16a circumferentially overlaps the mounting surface 282 of the connecting portion 28 in the axial direction. The plurality of mounting holes 284 of the connecting portion 28 align with of the mounting holes 162 of the first connecting portion 16a. A screw fastener (not shown) may thus be inserted through the mounting holes 162 from an outer side and threadly engages the mounting holes 284. In this way, the first arm body 10a can be fixed to the third arm body 20 via screw connection. Also, since the engineer can handle the screw fastener at the outer side of the tubular body without accessing the inner side of the tubular body, it is technically unnecessary to provide a further work opening.

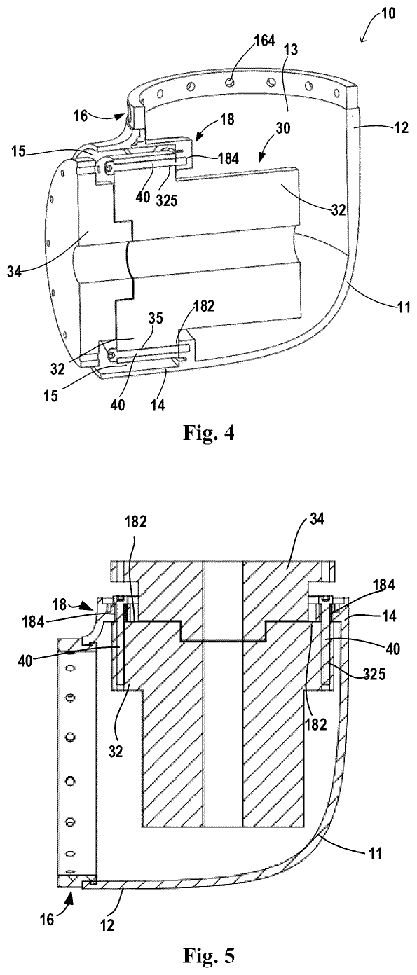

In some embodiments, as shown in FIGS. 2-4, the second connecting portion 18 may include an annular flange portion protruding from an inner surface of and second tubular portion to partially block the axial opening 15. By provision of the annular flange portion 18, as shown in FIG. 4, a fixed part 32 of the actuator 30 may be fixed to the arm body 10.

In some embodiments, the annular flange portion 18 may be made of metal. This is advantageous for ensuring connection strength of the plastic arm body 10 with the fixed part 32 of the actuator 30. The fixed part 32 may also be made of metal. When the annular flange portion 18 is made of metal, connection strength between the plastic arm body 10 and the fixed part 32 of the actuator 30 can be ensured. An axial end surface of the annular flange portion 18 provides the mounting surface 182. As shown in FIGS. 2-4, an outer axial end surface of the annular flange portion 18 opposite to the inner chamber is used as the mounting surface 184.

The annular flange portion 18 may include a plurality of second mounting holes 184 for screw connection. The second mounting holes 184 are circumferentially distributed along the mounting surface and are configured to receive a screw fastener from a side of the axial opening opposite to the inner chamber.

As shown in FIG. 4, a mounting hole 325 (a through hole in the shown example) may be provided in the fixed part 32. A mounting hole 184 (in the shown example, a thread hole) may be provided in the annular flange portion 18. A screw fastener 40 can be inserted into the mounting hole 184 from an outside of the arm body 10 and further engages the mounting hole 184 in the annular flange portion 18. In this way, the fixed part 32 of the actuator 30 can be fixed to the plastic arm body 10 via screw connection. Since the engineer can handle the screw fastener at the outer side of the tubular body without accessing the inner side of the tubular body, it is technically unnecessary to provide a further work opening. There are various means for forming the annular flange portion 18. In some embodiments, the first annular flange portion 18 may be integrally formed with the tubular body 11 via insert molding. In some embodiments, the annular flange portion 18 may be mechanically fixed to the tubular body, for example, via adhesion and the like.

In some embodiments, the annular flange portion 18 may be made of combination of plastic material and a metal member (for example, a plate-shaped member). The plastic material may be used as a substrate and the metal member may be embedded in the plastic substrate. The metal member may be used for forming the mounting interface. The metal member may be of a metal flat plate form and a plurality of mounting holes. The mounting holes may be thread holes and the screw fastener can engage the thread holes so as to fix the fixed part of the actuator to the annular flange portion 18. As for the annular flange portion 18 may be made of combination of plastic material and a metal member, in one embodiment, the annular flange portion 18 may be integrally formed with the tubular body 11 by insert molding. In another embodiment, the substrate of the annular flange portion 18 may firstly be integrally formed with the tubular body 11 by injection molding and the metal member is then mechanically fixed to the substrate, for example, via adhesion and the like.

In some embodiments, the annular flange portion 18 may be made of the plastic material. As shown in FIG. 3, a plurality of second mounting holes 184 may be provided in the annular flange portion 18. Each of the plurality of second mounting holes 184 may be provided with a metal insert 186 therein. A mounting hole 184 for screw connection is provided in the metal insert 186. The screw fastener can engage the thread holes in the metal insert 186. With provision of the metal insert 186, the screw fastener 40 is separated from the plastic material and does not directly contact the plastic material. Thus, the screw fastener 40 is not subject to compression caused by creep of the plastic material.

The annular flange portion 18 includes an inner axial end surface which is within the inner chamber of the tubal body and an outer axial end surface opposite to the inner chamber. The inner axial end surface or the outer axial end surface may be used as the mounting surface. In some embodiments, as shown in FIGS. 2-4, as best shown in FIG. 4, the annular flange portion 18 is provided within the inner chamber and the outer axial end surface is used as the mounting surface 182. A corresponding mounting surface of the fixed part 32 abuts against the outer axial end surface of the annular flange portion 18. The screw 40 which may be of a long length is used for connecting the fixed part 32 to the annular flange portion 18 of the arm body 10.

In the shown example embodiment, the annular flange portion 18 forms the attaching surface. In other example embodiment (not shown), instead of the flange portion, a plurality of connecting posts may arranged around the axial opening and is configured to form the attaching surface configured to fixed to other component constituting the robot. The plurality of connecting posts may extend in an axial direction in which the axial opening extends and align with each other at their axial end. Thus, an axial plane defined by axial end surfaces of the plurality of connecting posts forms the mounting surface. In some example embodiment, the plurality of connecting posts is integrally formed with the tubular body by injection molding. In some example embodiment, the plurality of connecting posts each may be made of metal and each comprises a mounting hole for screw connection. The mounting hole is configured to receive screw fasteners from a side of the axial opening opposite to the inner chamber.

In some example embodiment, the plurality of connecting posts may be made of the plastic material. A mounting hole may be provided in the each of the plurality of connecting posts. The mounting hole is provided with a metal insert therein; and the metal insert is configured to receive a screw fastener from a side of the axial opening opposite to the inner chamber.

In some example embodiment, the plurality of connecting posts is made of the plastic material; and a metal insert is arranged within the connecting post. The metal insert includes a second mounting hole for screw connection and configured to receive a screw fastener from a side of the axial opening opposite to the inner chamber.

The plurality of connecting posts may be provided at proper positions of tubular body. In some embodiment, the connecting post may be provided within the inner chamber at a distance from a terminal end of the respective tubular portion. In some embodiment, the plurality of connecting posts is provided at a terminal end of the respective tubular portion.

In the shown example embodiment, as shown in FIGS. 2-4, the first connecting portion 16 and the second connecting portion 18 are different from each other. As for the first connecting portion 16, the lengthwise inner or outer surface of the tubular body forms its attaching surface. As for the second connecting portion 18, the inner or outer axial end surface of the annular flange forms its attaching surface. It is to be understood that this is merely illustrative and the first connecting portion and the second connecting portion may be of the same type.

FIG. 5 shows a perspective view of a robotic arm including one arm body according to a second example embodiment of the present disclosure. Configuration of FIG. 5 is analogous to that of FIG. 4. The difference is that the annular flange portion 18 of FIG. 5 is provided at a terminal end of the tubular portion 14 and an inner axial end surface of the annular flange portion is used as the mounting surface 182.

As shown in FIG. 5, an inner axial end surface of the annular flange portion 18 facing the inner chamber may provide the mounting surface 182. The annular flange portion 18 may include a plurality of second mounting holes 184 for screw connection. The second mounting holes 184 are circumferentially distributed along the mounting surface and are configured to receive a screw fastener 40 from a side of the axial opening opposite to the inner chamber. In the shown example, the second mounting holes 184 may be through holes. In some embodiments, a metal sleeve may be arranged within the second mounting hole 184. The metal sleeve is used as a compress limiter. With provision of the metal sleeve, the screw fastener 40 is not subject to compression caused by creep of the plastic material.

A mounting hole 325 (a thread hole in the shown example) may be provided in the fixed part 32. The screw fastener 40 can be inserted into second mounting hole 184 in the annular flange portion 18 from an outside of the arm body 10 and further engages the mounting hole 325 in the fixed part 32. In this way, the fixed part 32 of the actuator 30 can be fixed to the plastic arm body 10 via screw connection. Also, since the engineer can handle the screw fastener at the outer side of the tubular body without accessing the inner side of the tubular body, it is technically unnecessary to provide a further work opening.

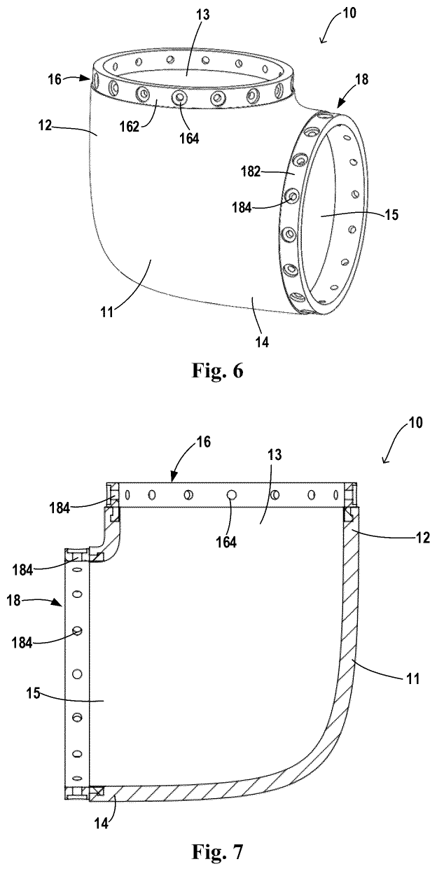

FIGS. 6 and 7 show different views of a robotic arm including one arm body 10 according to a third example embodiment of the present disclosure. The configuration of the arm in FIGS. 6-7 is analogous to that shown in FIGS. 2 and 5, and the differences is that both the first and second connecting portions 16, 18 are substantially the same and are in a form of a metal ring.

As shown in FIGS. 6 and 7, the first connecting portion 16 is a metal ring which extends in a lengthwise direction corresponding to the axial direction in which the opening extends. The outer or inner surface of the metal ring may be used as the mounting surface 162. When the tubular body is of a cylindrical shape, the radial outer or inner circumferential surface of the metal ring is used as the mounting surface. In some embodiments, the first connecting portion 16 may be integrally formed with the tubular body via insert molding. In some embodiments, the first connecting portion 16 may be mechanically fixed to the tubular body, for example, via adhesion and the like. The first connecting portion 16 may include one or more mounting holes 164 for screw connection. The mounting holes 164 are circumferentially distributed in the mounting surface 162.

Likewise, the second connecting portion 18 may be a metal ring which extends in a lengthwise direction corresponding to the axial direction in which the opening extends. The outer or inner surface of the metal ring may be used as the mounting surface 184. When the tubular body is of a cylindrical shape, the radial outer or inner circumferential surface of the metal ring is used as the mounting surface 184. The second connecting portion 18 may include one or more mounting holes 184 for screw connection. The mounting holes 184 are circumferentially distributed in the mounting surface. Since the first mounting holes 164 and the mounting holes 184 are radially arranged, an engineer can access the mounting holes from a radial outside of the arm body without need to access an inner side of the arm body.

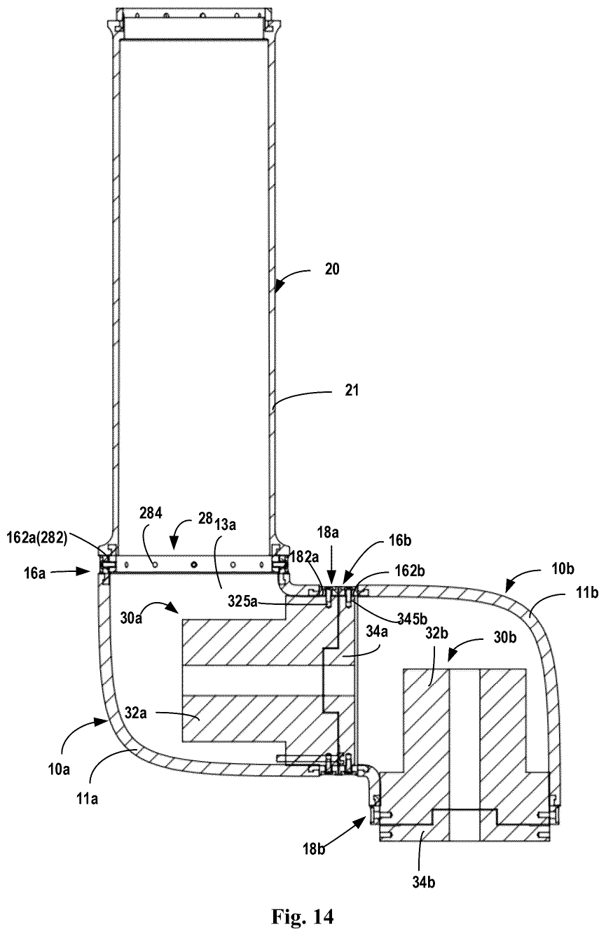

Connecting manners of how the first and second connecting portions 16, 18 of the arm body 10 in FIGS. 6 and 7 is connected to an adjacent member are best shown in FIG. 14. In FIG. 14, the arm body is labeled as 10a.

As shown in FIG. 14, a first connecting portion 16a is located at one axial end of a first arm body 10a and a second connecting portion 18a is located at the other axial end of the first arm body 10a. A third arm body 20 includes a connecting portion 28. The connecting portion 28 of the third arm body 20 is in a form of metal ring and takes the substantially same configuration as the first connecting portion 16a. The first connecting portion 16a may include a plurality of mounting holes 164 (referring to FIGS. 6 and 7). The connecting portion 28 may include a plurality of mounting holes 284. When the first arm body 10a and the third arm body 20 are placed in position and are to be assembled, the mounting surface 162a of the first connecting portion 16a circumferentially overlaps the mounting surface 282 of the connecting portion 28 in the axial direction. The plurality of mounting holes 284 of the connecting portion 28 align with of the mounting holes 164 of the first connecting portion 16a. A screw fastener 40 can be inserted through the mounting holes 162 from an radial outer side of the tubular body and threadly engages the mounting holes 284. In this way, the first arm body 10a can be fixed to the third arm body 20 via screw connection.

FIG. 14 also shows how the first arm body 10a is connected to a fixed part 32a of a first actuator 30 at the second connecting portion 18a. As shown in FIG. 14, the fixed part 32a may include a plurality of mounting holes 325a at its radial outer side. The second connecting portion 18a may include a plurality of mounting holes 184. When the fixed part 32a of the first actuator 30 is placed in position within the inner chamber, a mounting surface 182a of the second connecting portion 18a circumferentially overlaps a corresponding mounting surface of the fixed part 32a. The plurality of mounting holes 325a of the fixed part 32a aligns with of the mounting holes 184 of the second connecting portion 18a. A screw fastener 40 may be inserted through the mounting holes 182 from a radial outer side of the tubular body and threadly engages the fixed part 32a. In this way, the first arm body 10a can be fixed to the fixed part 32a of the actuator via screw connection.

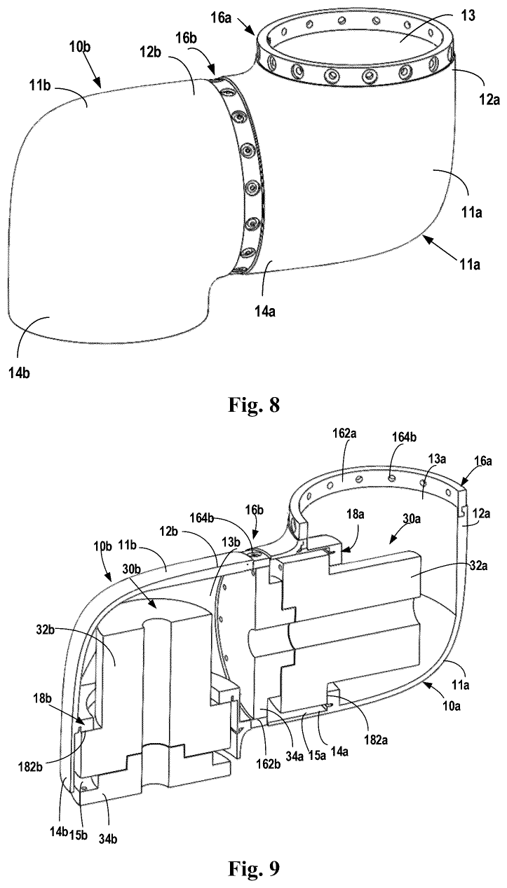

FIGS. 8 and 9 show different views of a robotic arm 10 including two arm bodies 10a, 10b according to one example embodiment of the present disclosure. The arm formed by the two arm bodies 10a, 10b are substantially closed without openings. As shown in FIGS. 8 and 9, the two arm bodies 10a, 10b are substantially the same and each of the two arm bodies 10a, 10b are substantially closed except its axial openings. Configurations of the arm body 10a, 10b are substantially the same as those shown in FIGS. 2-4. The reference symbols in FIGS. 8 and 9 are substantially the same as those in FIGS. 2-4 but followed by suffixes “a, b”.

As shown in FIGS. 8 and 9, within each arm body 10a, 10b, an actuator 30a, 30b is provided. First, a fixed part 32a of the first actuator 30a may be fixed to the first tubular body 11a at the second connecting portion 18a via the second opening 15a. Likewise, a fixed part 32b of the second actuator 30b may be fixed to the second tubular body 11b at the second connecting portion 18b via the second opening 15b. During this assembly process, a screw fastener can be inserted, from a respective axial opening side, through the mounting holes (not shown) provided in the fixed part 32a, 32b and into the mounting holes (not shown) provided in the second connection portion 18a, 18b. Thus, the engineer does not have to access the inner side of the chamber.

Then, the second tubular body 11b of the second arm body 10b, at its first opening 13b side, can align with the first tubular body 11a of the first arm body 10a at its second opening 15a side. As shown in FIG. 9, an outer side surface of movable part 34a of the first actuator 30a may be used to locate the second tubular body 11b of the second arm body 10b. When the second arm body 10b and the first arm body 10a are in position, the second tubular body 11b can be fixed to a movable part 34a of the first actuator 30a. Thus, the two arm bodies 10a, 10b are connected together.

As shown in FIGS. 8 and 9, the first connection portion 16b of the second tubular body 11b is radially exposed to the engineer. Thus, a screw fastener (not shown) can be inserted, from the radial outer side of the arm body, through the mounting holes 164b provided in first connection portion 16b of the second tubular body 11b and into the mounting holes (not shown) provided in a movable part 34a of the first actuator 30a. Again, the engineer does not have to access the inner side of the chamber to realize the connection between the actuator and the second tubular body 11b.

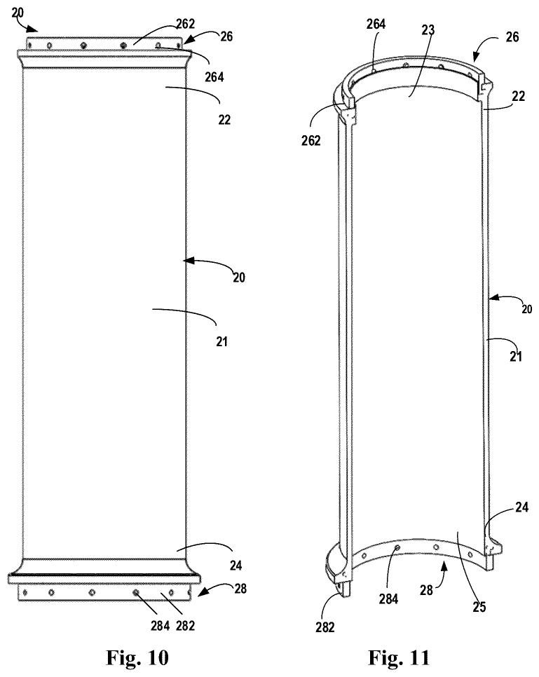

FIGS. 10 and 11 show a robotic arm including one arm body according to a fourth example embodiment of the present disclosure. The arm body 20 may be used as the connecting arm shown in FIG. 1. As shown in FIGS. 10 and 11, the arm body 20 may include an arm body 21 in form of a tubular body which is substantially closed except a first axial opening 23 and the second axial opening 25. The tubular body may be straight and comprising a first tubular portion 22 and a second tubular portion 24 at its opposite end. A end wall of the first tubular portion 22 defines the first axial opening 23. A first connecting portion 26 is provided at the first tubular portion 22. The first connecting portion 16 may be a metal ring. The first connecting portion 26 includes a mounting surface 262. The first connecting portion 26 may include a plurality of first mounting holes 264 for screw connection. The first mounting holes 264 are circumferentially distributed in the mounting surface.

Likewise, an end wall of the second tubular portion 24 defines the second axial opening 25. The second connecting portion 28 is provided at the second tubular portion 14. The second connecting portion 28 includes a mounting surface 282. The first connecting portion 26 may be a metal ring. In one example, as shown in FIGS. 2-4, a fixed part 34 of the actuator 30 can be fixed to the arm body 10 at the second tubular portion 14 via the first mounting surface 182. The second connecting portion 28 includes a mounting surface 282. The second connecting portion 28 may include a plurality of second mounting holes 284 for screw connection. The mounting holes 284 are circumferentially distributed in the mounting surface.

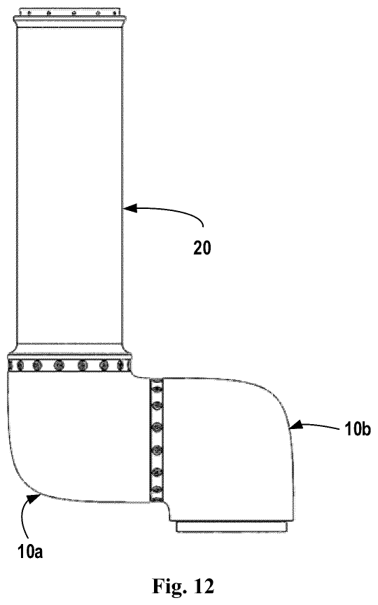

FIGS. 12 to 14 show different views of a robotic arm including three arm bodies according to one example embodiment of the present disclosure. As shown in FIG. 12, the robotic arm including three arm bodies are substantially closed without provision of work openings. In configuration shown in FIG. 13 the arm bodies 10a, 10b are substantially the same as the arm body 10 shown in FIGS. 2-4 while in configuration shown in FIG. 14 the arm bodies 10a, 10b are substantially the same as the arm body 10 shown in FIGS. 6 and 7.

As shown in FIGS. 13 and 14, after two bodies 10a, 10b are connected together, a third body 20 can be fixed to the assembly body of the two bodies 10a, 10b. In the shown example, some location features, for example, a step or a flange, may be provided at the connection portions 16a, and 28. These location features may facilitate connection between the arm bodies. When the assembly body and the third body 20 are placed in position, the connection portion 28 of the third arm body 20 can be received in the axial opening 13a of the first arm body 10a. Thus, mounting holes provided in the first connection portion 16a of the first arm body 10a align the mounting holes 284 provided in the connection portion 28 of the third arm body 20. The first connection portion 16a of the second tubular body 11a is radially exposed to the engineer. Thus, a screw fastener can be inserted, from the radial outer side of the arm body, through the mounting holes provided in first connection portion 16a of the tubular body 11a and into the mounting holes 284 provided in the connection portion 28 of the third arm body 20. In this way, the third arm body 20 can be fixed to the assembly body of the two bodies 10a, 10b. Again, the first arm body 10a can be fixed to the third arm body 20 and the engineer does not have to access the inner side of the chamber.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. An arm body for a robotic arm, comprising:
a first tubular body made of plastic material, comprising:
a first tubular portion comprising:
a first axial opening communicating with an inner chamber of the first tubular body; and
a second tubular portion comprising:
a second axial opening communicating with the inner chamber,
the first tubular body being substantially closed except the first axial opening and the second axial opening
a first connecting portion provided at the first tubular portion and comprising:
a first mounting surface configured to be connected to a first component constituting a robot; and
a second connecting portion provided at the second tubular portion and comprising a second mounting surface configured to be connected a second component constituting the robot.

2. The arm body according to claim 1, wherein at least one connecting portion of the first connecting portion and the second connecting portion is made of metal; and
the respective mounting surface of the at least one connecting portion extends in a lengthwise direction in which the respective axial opening extends.

3. The arm body according to claim 2, wherein the at least one connecting portion is a ring-shaped member; and
the at least one connecting portion comprises:
a plurality of first mounting holes circumferentially distributed along the respective mounting surface, the first mounting hole extending in a thickness direction of the at least one connecting portion perpendicular to the lengthwise direction and configured to receive a screw fastener.

4. The arm body according to claim 2, wherein the at least one connecting portion is integrally formed with the first tubular body by insert molding or adhesive.

5. The arm body according to claim 1, wherein at least one of the first connecting portion and the second connecting portion comprises an annular flange portion protruding from an inner surface of the respective tubular portion to partially block the respective axial opening, or a plurality of connecting posts arranged around the respective axial opening and extending in an axial direction in which the respective axial opening extends, an axial end surface of the annular flange portion or an axial plane defined by axial end surfaces of the plurality of connecting posts forming the respective mounting surface, and
the annular flange portion or the plurality of connecting posts is integrally formed with the first tubular body by injection molding.

6. The arm body according to claim 5, wherein the annular flange portion or the plurality of connecting posts is made of metal and comprises a second mounting hole for screw connection; and
the second mounting hole is configured to receive screw fasteners from a side of the axial opening opposite to the inner chamber.

7. The arm body according to claim 6, wherein the annular flange portion or the plurality of connecting posts is made of the plastic material;
a second mounting hole is provided in the annular flange portion or the plurality of connecting posts, the second mounting hole is provided with a metal insert therein; and
the metal insert is configured to receive a screw fastener from a side of the axial opening opposite to the inner chamber.

8. The arm body according to claim 6, wherein the annular flange portion or the plurality of connecting posts is made of the plastic material;
a metal insert is arranged within the annular flange portion or the connecting post; and
the metal insert comprises a second mounting hole for screw connection and configured to receive a screw fastener from a side of the axial opening opposite to the inner chamber.

9. The arm body according to claim 5, wherein the annular flange portion or the plurality of connecting posts is provided within the inner chamber at a distance from a terminal end of the respective tubular portion.

10. The arm body according to claim 5, wherein the annular flange portion or the plurality of connecting posts is provided at a terminal end of the respective tubular portion.

11. A robotic arm comprising:
the arm body according to claim 1; and
a first actuator comprising:
a fixed part and a movable part
the fixed part being received within an inner chamber of a first tubular body of the arm body and being fixed to the arm body via one of a first connecting portion and a second connecting portion of the arm body.

12. The robotic arm according to claim 11, further comprising
a second arm body comprising:
a second tubular body made of plastic material and a third axial opening and a fourth axial opening at opposite ends of the second tubular body the second tubular body being substantially closed except the third axial opening and the fourth axial opening
a third connecting portion provided at the third axial opening and comprising a third mounting surface and
a fourth connecting portion provided at the fourth axial opening and comprising a fourth mounting surface and
wherein the second tubular body is fixed to the first tubular body via engagement of one of the third mounting surface and the fourth mounting surface with one of the first mounting surface and the second mounting surface.

13. The robotic arm according to claim 12, wherein the first tubular body is curved in an L-shape, and/or the second tubular body is in a straight arm shape.

14. The robotic arm according to claim 11, further comprising:
a third arm body comprising:
a third tubular body made of plastic material and a fifth axial opening and a sixth axial opening at opposite ends of the third tubular body
a fifth connecting portion provided at the fifth axial opening and comprising a fifth mounting surface and
a sixth connecting portion provided at the sixth axial opening and comprising a sixth mounting surface and
wherein at least part of the movable part of the first actuator comprises a plurality of third mounting holes and extends beyond a terminal end of the first tubular body and the third arm body is fixed to the first arm body via engagement of the at least part of the movable part and one of the fifth mounting surface and the sixth mounting surface.

15. The robotic arm according to claim 13, further comprising:
a second actuator comprising:
a fixed part and a movable part
wherein the fixed part of the second actuator is received within an inner chamber of the third tubular body and comprises a plurality of fourth mounting holes, and the second actuator is fixed to the third arm body via engagement of the fixed part and the other mounting surface of the fifth mounting surface and the sixth mounting surface.

16. An industrial robot comprising
a base, and
a robotic arm comprising the arm body according to claim 1.
